(19) United States
(12) Patent Application Publication
(10) Pub. No.: US 2022/0076907 A1
(43) Pub. Date: Mar. 10, 2022

(54) MEMBRANE CIRCUIT BOARD OF KEYBOARD AND KEYBOARD STRUCTURE

(71) Applicant: LITE-ON Technology Corporation, Taipei City (TW)

(72) Inventor: Kuo-Hui HSU, Taipei City (TW)

(73) Assignee: LITE-ON Technology Corporation, Taipei City (TW)

(21) Appl. No.: 17/385,932

(22) Filed: Jul. 27, 2021

Related U.S. Application Data
(60) Provisional application No. 63/074,920, filed on Sep. 4, 2020.

(30) Foreign Application Priority Data
Apr. 12, 2021 (CN) 202120739615.1

(51) Int. Cl. H01H 13/7065; H01H 13/10

(52) U.S. Cl. CPC H01H 13/7065; H01H 13/10

(57) ABSTRACT

The present disclosure provides a membrane circuit board of keyboard and a keyboard structure. The membrane circuit board of keyboard includes a first film, a first air channel, a second film, a second air channel, and a third film. The first film includes a first circuit pattern. The first air channel is disposed on the first film. The second film is disposed on the first air channel, and the second film includes an air hole. The second air channel is disposed on the second film, and the second air channel is in fluid communication with the air hole and the first air channel. The third film is disposed on the second air channel, and the third film includes a second circuit pattern.

### CROSS REFERENCE TO RELATED DISCLOSURE

This application claims the priority benefit of American Provisional Application Number U.S. 63/074,920, filed on Sep. 4, 2020 and Chinese Patent Application Number CN202120739615.1, filed on Apr. 12, 2021, the full disclosure of which are incorporated herein by references.

### BACKGROUND

### Technical Field

The present disclosure relates to the technical field of a keyboard, particularly to a membrane circuit board of keyboard and a keyboard structure.

### Related Art

With the development of science and technology, electronic products are gradually developing towards the trend of light, thin, short, and small. For example, a membrane keyboard is used for a laptop. More specifically, a membrane circuit board in the membrane keyboard is usually a three-film structure. For the three-film structure, when internal gas existing in the film structure changes a spacing between the films due to thermal expansion and contraction, the sensitivity of the membrane circuit board decreases. Therefore, an air channel may be further disposed in the membrane circuit board, and an opening of the air channel is disposed on a surface of the membrane circuit board. Thus, the internal gas may be exhausted along the air channel.

However, the membrane circuit board with the air channel is not sealing. As a result, water enters the three-film structure from the opening of the air channel, which causes the membrane circuit board to short-circuit. Therefore, the problem of improving the water resistance of the membrane circuit board while maintaining the exhaust function has become an urgent problem to be solved.

### SUMMARY

The embodiments of the present disclosure disclose a membrane circuit board and a keyboard structure, in order to solve the problem of damaging the keyboard due to the entry of water from the air channel to the membrane circuit board.

In order to solve the above technical problems, the present disclosure is implemented as follows.

In the first aspect, the present disclosure provides a membrane circuit board of keyboard, including a first film, a first air channel, a second film, a second air channel, and a third film. The first film includes a first circuit pattern. The first air channel is disposed on the first film. The second film is disposed on the first air channel, and an air hole is passed through the second film. The second air channel is disposed on the second film, and the second air channel is in fluid communication with the air hole and the first air channel. The third film is disposed on the second air channel, and the third film includes a second circuit pattern.

In the second aspect, the present disclosure provides a membrane circuit board of keyboard, including a first film, a first air channel, a second film, a second air channel, and a third film. The first film includes a first circuit pattern and a first air hole. The first air channel is disposed on the first film, and the first air channel is in fluid communication with the first air hole. The second film is disposed on the first air channel, and the second film includes a second air hole. The second air channel is disposed on the second film. The second air channel is in fluid communication with the first air channel and the second air hole. The third film is disposed on the second air channel, and the third film includes a second circuit pattern.

In the third aspect, the present disclosure provides a keyboard structure, including a bottom plate, the membrane circuit board of the keyboard according to the first aspect, a rubber element, a cap, and a supporting assembly. The membrane circuit board is disposed on the bottom plate. The rubber element is disposed on the membrane circuit board. The cap movably connects to the rubber element. Two ends of the supporting assembly respectively connect to the bottom plate and the cap.

In the fourth aspect, the present disclosure provides a keyboard structure, including a bottom plate, the membrane circuit board of the keyboard according to the second aspect, a rubber element, a cap, and a supporting assembly. The membrane circuit board is disposed on the bottom plate. The rubber element is disposed on the membrane circuit board. The cap movably connects to the rubber element. Two ends of the supporting assembly respectively connect to the bottom plate and the cap.

In the embodiment of the present disclosure, the exhaust path of the membrane circuit board and the keyboard are more complicated through the first air channel, the second air channel, and the air hole. In this way, when the water enters the membrane circuit board from the opening of the air channel, the penetration time increases due to the complicated exhaust path. That is, the waterproofness of the membrane circuit board and the keyboard is improved. Furthermore, the air hole in the membrane circuit board may also have a function similar to a detention basin, therefore the affordability of the water content of the membrane circuit board is improved.

### BRIEF DESCRIPTION OF THE DRAWINGS

The Figures described herein are used to provide a further understanding of the present disclosure and constitute a part of the present disclosure. The exemplary embodiments and descriptions of the present disclosure are used to illustrate the present disclosure and do not limit the present disclosure, in which:

FIG. 1 is a cross-sectional view of the membrane circuit board of the keyboard according to the first embodiment of the present disclosure;

FIG. 2 is a cross-sectional view of the membrane circuit board of the keyboard according to the second embodiment of the present disclosure;

FIG. 3 is a cross-sectional view of the membrane circuit board of the keyboard according to the third embodiment of the present disclosure;

FIG. 4 is a cross-sectional view of the membrane circuit board of the keyboard according to the fourth embodiment of the present disclosure;

FIG. 5 is a cross-sectional view of the membrane circuit board of the keyboard according to the fifth embodiment of the present disclosure;

FIG. 6 is a cross-sectional view of the membrane circuit board of the keyboard according to the sixth embodiment of the present disclosure;

FIG. 7 is a schematic diagram of the keyboard structure according to the seventh embodiment of the present disclosure; and

FIG. 8 is an exploded view of the keyboard structure according to the seventh embodiment of the present disclosure.

### DETAILED DESCRIPTION OF THE EMBODIMENTS

In order to make the objectives, technical solutions, and advantages of the present disclosure clearer, the technical solutions of the present disclosure will be described clearly and completely in conjunction with specific embodiments and the Figures of the present disclosure. Obviously, the described embodiments are only a part of the embodiments of the present disclosure, rather than all the embodiments. Based on the embodiments in the present disclosure, all other embodiments obtained by a person of ordinary skill in the art without creative work fall within the protection scope of this disclosure.

The following description is of the best-contemplated mode of carrying out the present disclosure. This description is made for the purpose of illustrating the general principles of the present disclosure and should not be taken in a limiting sense. The scope of the present disclosure is best determined by reference to the appended claims.

Moreover, the terms “include”, “contain”, and any variation thereof are intended to cover a non-exclusive inclusion. Therefore, a process, method, object, or device that comprises a series of elements not only includes these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

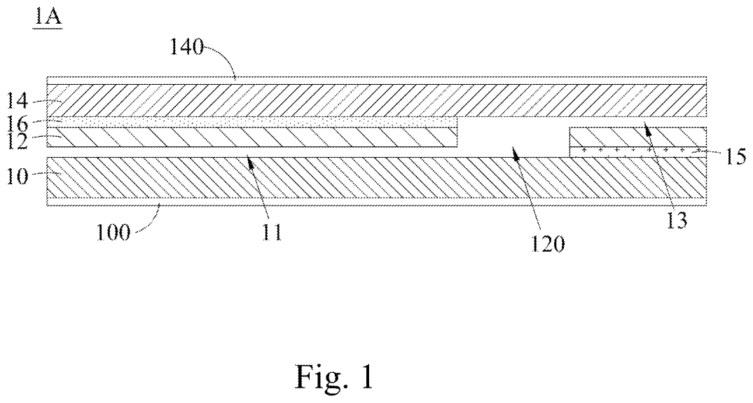

FIG. 1 is a cross-sectional view of the membrane circuit board of the keyboard according to the first embodiment of the present disclosure. As shown in the figure, the membrane circuit board 1A of the keyboard includes a first film 10, a first air channel 11, a second film 12, a second air channel 13, and a third film 14.

The first film 10 may include polyvinyl chloride (PVC), polyethylene (PE), polypropylene (PP), polycarbonate (PC), polyethylene terephthalate (PET), polymethyl methacrylate (PMMA), polyurethane (PU), polyimide (PI), and/or a combination thereof. However, the present disclosure is not limited thereto. Any material recognized by a person of ordinary skill in the art may be applied to the present disclosure. In addition, the first film 10 includes a first circuit pattern 100. For example, the first circuit pattern 100 may be formed on the first film 10 by printing or transfer. In addition, the first circuit pattern 100 may include pure metal, metal alloy, metal nitride, metal oxide, metal oxynitride, and/or a combination thereof, but the present disclosure is not limited thereto.

The first air channel 11 is disposed on the first film 10 and used to exhaust internal gas. In some embodiments, one end of the first air channel 11 may be passed through a side surface of the membrane circuit board 1A. That is, the side surface of the membrane circuit board 1A has an opening of the first air channel 11. In this way, when the temperature of the membrane circuit board 1A increases, the internal gas with increased pressure may move along the first air channel 11 and exhaust from the opening of the first air channel 11. On the other hand, when the temperature of the membrane circuit board 1A decreases, the pressure of the internal gas decreases. Therefore, external gas may enter from the opening of the first air channel 11 so that the pressure of the membrane circuit board 1A may be kept constant.

The second film 12 is disposed on the first air channel 11. The second film 12 may include a material similar to or the same as the material of the first film 10. Alternatively, in some embodiments, the second film 12 may also include a different material from the material of the first film 10. That is, various materials may be selected for the second film 12 according to actual conditions. However, it should be noted that the second film 12 is used to insulate a first circuit pattern 100 on the first film 10 and a second circuit pattern 140 (which will be described hereinafter) on the third film 14 from each other. Therefore, a non-conductive material needs to be selected for the second film 12 to prevent the first circuit pattern 100 and the second circuit pattern 140 from the short circuit therebetween.

In addition, the second film 12 includes an air hole 120. The air hole 120 is passed through the second film 12 along a vertical direction (that is, perpendicular to the second film 12). The air hole 120 is used to connect the first air channel 11 to the second air channel 13. The “connect” herein refers to “fluid communicate”, that is, the internal gas may move in the first air channel 11, the second air channel 13, and the air hole 120. In some embodiments, the air hole 120 may also have a function similar to a detention basin. That is, when the size of the air hole 120 is larger, more water may be contained in the air hole 120. Therefore, the size of the air hole 120 may be disposed according to the actual situation to further delay the penetration of water.

The second air channel 13 is disposed on the second film 12, and the second air channel 13 is in fluid communication with the air hole 120 and the first air channel 11. Compared with the membrane circuit board in the prior art, the membrane circuit board 1A of the present disclosure has an additional air hole 120 and a second air channel 13 to make the exhaust path more complicated. In other words, when the water enters the membrane circuit board 1A along the air channel, the penetration time increases due to the complicated exhaust path. Therefore, the waterproofness of the membrane circuit board 1A is effectively improved.

The third film 14 is disposed on the second air channel 13, and the third film 14 includes a second circuit pattern 140. The second film 12 may include a material similar to or the same as the material of the first film 10. In addition, the second circuit pattern 140 may include a material similar to or the same as the material of the first circuit pattern 100, and be disposed on the second air channel 13 in a similar or the same method. Therefore, the description thereof is omitted. However, it should be noted that, in some embodiments, the third film 14 and the second circuit pattern 140 may be selected from a different material and a disposed method from the first film 10 and the first circuit pattern 100 according to actual conditions.

In some embodiments, the membrane circuit board 1A may further include a first adhesive 15 and a second adhesive 16. The first adhesive 15 is used for adhering the first film 10 to the second film 12. Therefore, in the embodiments, the first adhesive 15 may be disposed between the first film 10 and the second film 12, and the first adhesive 15 and the first air channel 11 are on the same plane. The second adhesive 16 is used for adhering the second film 12 to the third film 14. Therefore, in the embodiments, the second adhesive 16 may be disposed between the second film 12 and the third film 14, and the second adhesive 16 and the second air channel 13 are on the same plane. Specifically, the first adhesive 15 and the second adhesive 16 may include latex, acrylic resin, epoxy resin, polyurethane, and/or a combination thereof, but the present disclosure is not limited thereto.

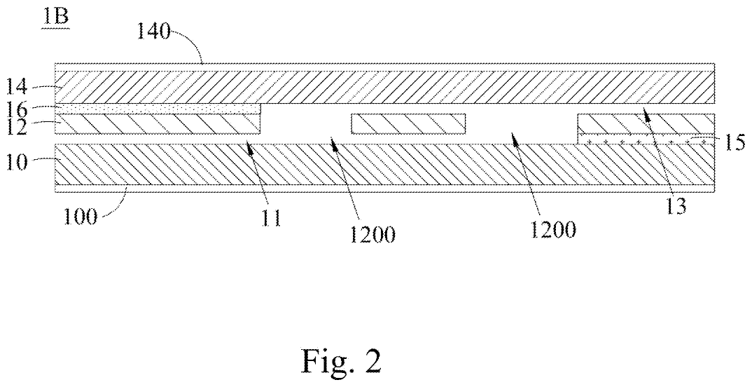

FIG. 2 is a cross-sectional view of the membrane circuit board of the keyboard according to the second embodiment of the present disclosure. As shown in the figure, the membrane circuit board 1B of the keyboard includes the first film 10, the first air channel 11, the second film 12, the second air channel 13, and a third film 14. In the present embodiment, the same reference numerals indicate the same elements in FIG. 1 and FIG. 2. Therefore, the detailed descriptions of the same elements are omitted.

Compared with the first embodiment, the air hole 120 of the present embodiment may include a plurality of sub air holes 1200, and the plurality of sub air holes 1200 respectively are in fluid communication with the first air channel 11 and the second air channel 13. That is, the plurality of sub air holes 1200 all have a function similar to a detention basin, therefore the affordability of the water content of the membrane circuit board 1B is improved. Specifically, the number of sub air holes 1200 in the present embodiment is two, but the present disclosure is not limited thereto. In some embodiments, the number of sub air holes 1200 may be 3, 4, 5, or more.

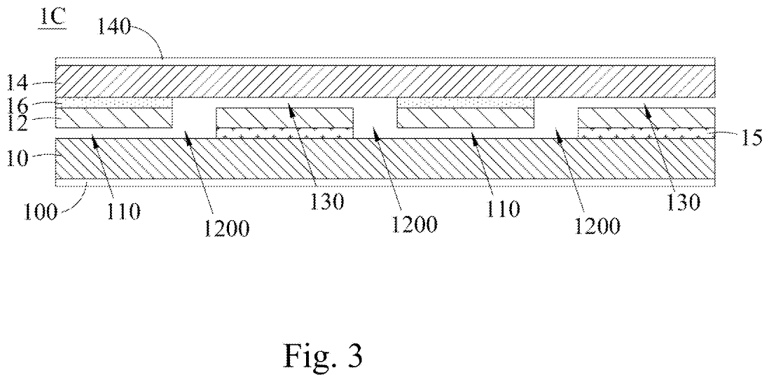

FIG. 3 is a cross-sectional view of the membrane circuit board of the keyboard according to the third embodiment of the present disclosure. As shown in the figure, the membrane circuit board 1C of the keyboard includes the first film 10, the first air channel 11, the second film 12, the second air channel 13, and a third film 14. In the present embodiment, the same reference numerals indicate the same elements in FIG. 1 and FIG. 3. Therefore, the detailed descriptions of the same elements are omitted.

Compared with the first embodiment, the air hole 120 of the present embodiment may include a plurality of sub air holes 1200, and the plurality of sub air holes 1200 respectively are in fluid communication with the first air channel 11 and the second air channel 13. In addition, the first air channel 11 may include a plurality of sub first air channels 110. The second air channel 13 may include a plurality of sub second air channels 130. In this way, through the plurality of sub first air channels 110, the plurality of sub second air channels 130, and the plurality of sub air holes 1200, the exhaust path may be more complicated. For example, the exhaust path may be extended effectively through the serpentine curve shown in FIG. 3, therefore the penetration of water is more difficult.

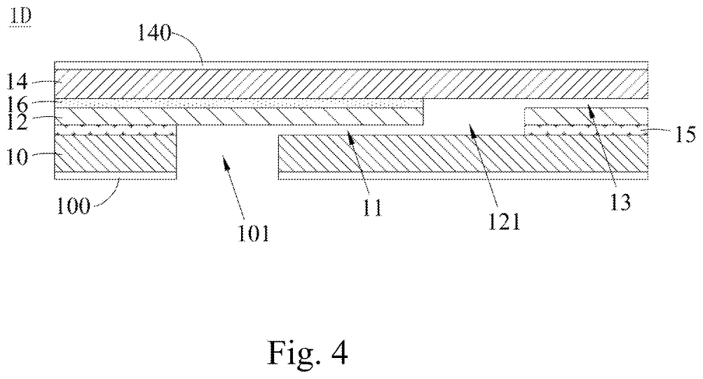

FIG. 4 is a cross-sectional view of the membrane circuit board of the keyboard according to the fourth embodiment of the present disclosure. As shown in the figure, the membrane circuit board 1D of the keyboard includes the first film 10, the first air channel 11, the second film 12, the second air channel 13, and the third film 14.

The first film 10 includes the first circuit pattern 100 and a first air hole 101. The first air channel 11 is disposed on the first film 10, and the first air channel 11 is in fluid communication with the first air hole 101. The second film 12 is disposed on the first air channel 11, and the second film 12 includes a second air hole 121. The second air channel 13 is disposed on the second film 12, and the second air channel 13 is in fluid communication with the first air channel 11 and the second air hole 121. The third film 14 is disposed on the second air channel 13, and the third film 14 includes the second circuit pattern 140. In the present embodiment, the same reference numerals indicate the same elements in FIG. 1 and FIG. 4. Therefore, the detailed descriptions of the same elements are omitted. In addition, the second air hole 121 may have a function similar to or the same as the function of the air hole 120, so the description thereof is omitted.

Compared with the first embodiment, the first film 10 of the present embodiment includes the first air hole 101, and one end of the first air hole 101 is passed through a surface of the first film 10 away from the first air channel 11. That is, the bottom surface of the membrane circuit board 1D has an opening connecting to the first air channel 11. In this way, when the temperature of the membrane circuit board 1D increases, the internal gas with increased pressure may move along the first air channel 11 and exhaust through the first air hole 101. On the other hand, when the temperature of the membrane circuit board 1A decreases, the pressure of the internal gas decreases. Therefore, external gas may also enter through the first air hole 101 to keep the pressure of the membrane circuit board 1D constant. In other words, for the membrane circuit board of the present disclosure, the opening used to exhaust may be disposed on the side surface or the bottom surface of the membrane circuit board according to requirements.

In some embodiments, the membrane circuit board 1D may further include a first adhesive 15 and a second adhesive 16. The first adhesive 15 is disposed between the first film 10 and the second film 12. The second adhesive 16 is disposed between the second film 12 and the third film 14.

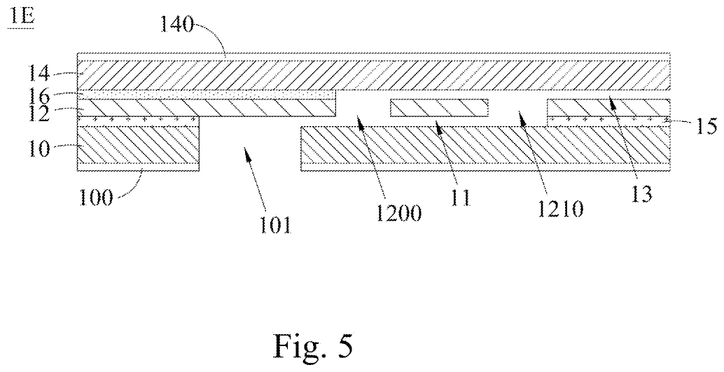

FIG. 5 is a cross-sectional view of the membrane circuit board of the keyboard according to the fifth embodiment of the present disclosure. As shown in the figure, the membrane circuit board 1E of the keyboard includes the first film 10, the first air channel 11, the second film 12, the second air channel 13, and the third film 14. In the present embodiment, the same reference numerals indicate the same elements in FIG. 4 and FIG. 5. Therefore, the detailed descriptions of the same elements are omitted.

The second air hole 121 may include a plurality of sub air holes 1210, and the plurality of sub air holes 1210 respectively are in fluid communication with the first air channel 11 and the second air channel 13. Compared with the fourth embodiment, the penetration of water may be further delay through the plurality of sub air holes 1210 in the present embodiment, therefore the waterproofness of the membrane circuit board 1E is improved.

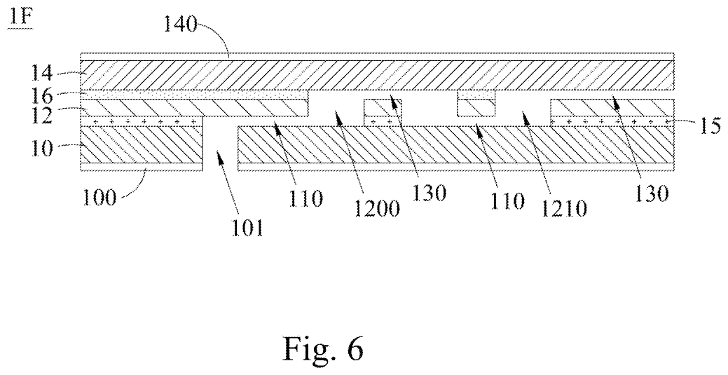

FIG. 6 is a cross-sectional view of the membrane circuit board of the keyboard of the sixth embodiment of the present disclosure. As shown in the figure, the membrane circuit board 1F of the keyboard includes the first film 10, the first air channel 11, the second film 12, the second air channel 13, and the third film 14. In the present embodiment, the same reference numerals indicate the same elements in FIG. 4 and FIG. 6. Therefore, the detailed descriptions of the same elements are omitted.

The second air hole 121 may include a plurality of sub air holes 1210, and the plurality of sub air holes 1210 respectively are in fluid communication with the first air channel 11 and the second air channel 13. In addition, the first air channel 11 may include a plurality of sub first air channels 110. The second air channel 13 may include a plurality of sub second air channels 130. In this way, the exhaust path may be more complicated through the plurality of sub first air channels 110, the plurality of sub second air channels 130, and the plurality of sub air holes 1210. For example, the exhaust path may be extended effectively through the serpentine curve shown in FIG. 6, therefore the penetration of water is more difficult.

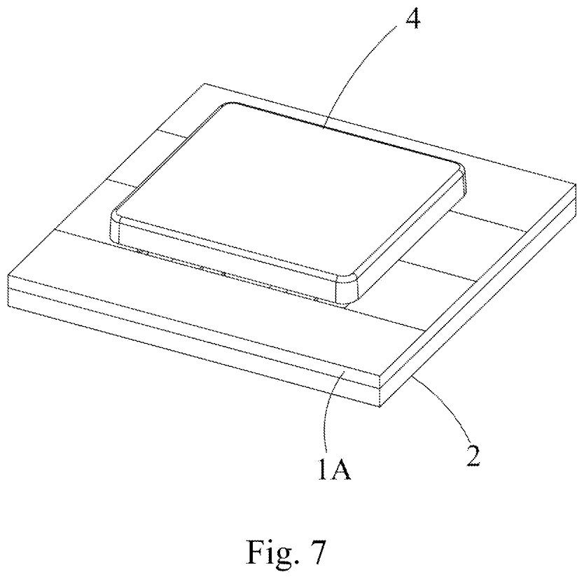

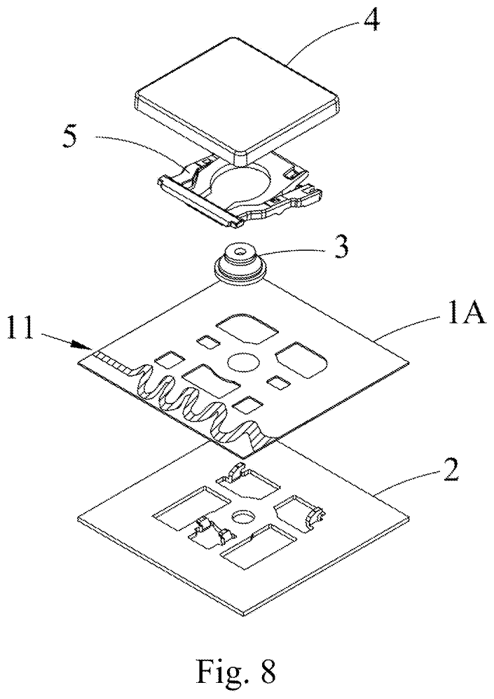

FIG. 7 and FIG. 8 are respectively a schematic diagram and an exploded view of the keyboard structure of the seventh embodiment of the present disclosure. As shown in the figure, the keyboard structure includes a bottom plate 2, the membrane circuit board 1A, a rubber element 3, a cap 4, and a supporting assembly 5. The membrane circuit board 1A is disposed on the bottom plate 2. The rubber element 3 is disposed on the membrane circuit board 1A. The cap 4 movably connects to the rubber element 3. The two ends of the supporting assembly 5 respectively connect to the bottom plate 2 and the cap 4. When the membrane circuit board 1A of the present disclosure is used for the keyboard structure, the penetration into the keyboard of water from the opening of the first air channel 11 in FIG. 8 may be effectively blocked and/or delay through the more complicated exhaust path.

It should be noted that the membrane circuit board 1A is used as an example in the present embodiment, but the disclosure is not limited thereto. Any one of the membrane circuit boards disclosed in the present disclosure may be applied to a keyboard to improve the waterproofness of the keyboard. For example, the membrane circuit board 1D may be used in the keyboard structure mentioned above. Compared to the membrane circuit board 1A, the first film of the membrane circuit board 1D further includes a first air hole. An end of the first air hole is passed through a surface of the first film away from the first air channel and is in fluid communication with the first air channel.

In summary, the exhaust path of the membrane circuit board and the keyboard are more complicated through the first air channel, the second air channel, and the air hole. In this way, when the water enters the membrane circuit board from the opening of the air channel, the penetration time increases due to the complicated path. That is, the waterproofness of the membrane circuit board and the keyboard is improved. Furthermore, the air hole in the membrane circuit board may also have a function similar to a detention basin, therefore the affordability of the water content of the membrane circuit board is improved.

A person of ordinary skill in the art will understand current and future manufacturing processes, method and step from the content disclosed in some embodiments of the present disclosure, as long as the current or future manufacturing processes, method, and step performs substantially the same functions or obtain substantially the same results as the present disclosure. Therefore, the scope of the present disclosure includes the above-mentioned manufacturing process, method, and steps.

The above descriptions are only examples of this application and are not intended to limit this application. This disclosure may have various modifications and changes for a person of ordinary skill in the art. Any modification, equivalent replacement, improvement, etc. made within the spirit and principle of this application shall be included in the scope of the claims of this disclosure.

What is claimed is:

1. A membrane circuit board of keyboard, comprising:
a first film comprising a first circuit pattern;
a first air channel disposed on the first film;
a second film disposed on the first air channel, wherein the second film comprises an air hole;
a second air channel disposed on the second film, wherein the second air channel is in fluid communication with the air hole and the first air channel; and
a third film disposed on the second air channel, wherein the third film comprises a second circuit pattern.

2. The membrane circuit board of keyboard according to claim 1, further comprising:
a first adhesive disposed between the first film and the second film; and
a second adhesive disposed between the second film and the third film.

3. The membrane circuit board of keyboard according to claim 1, wherein the air hole comprises a plurality of sub air holes, and the plurality of sub air holes are respectively in fluid communication with the first air channel and the second air channel.

4. The membrane circuit board of keyboard according to claim 1, wherein an end of the first air channel is passed through a side surface of the membrane circuit board of the keyboard.

5. A membrane circuit board of keyboard, comprising:
a first film comprising a first circuit pattern and a first air hole;
a first air channel disposed on the first film, wherein the first air channel is in fluid communication with the first air hole;
a second film disposed on the first air channel;
a second air channel disposed on the second film, wherein the second film comprises a second air hole, and the second air hole is in fluid communication with the first air channel and the second channel; and
a third film disposed on the second air channel, wherein the third film comprises a second circuit pattern.

6. The membrane circuit board of keyboard according to claim 5, further comprising:
a first adhesive disposed between the first film and the second film; and
a second adhesive disposed between the second film and the third film.

7. The membrane circuit board of keyboard according to claim 5, wherein the second air hole comprises a plurality of sub air holes, and the plurality of sub air holes are respectively in fluid communication with the first air channel and the second air channel.

8. The membrane circuit board of keyboard according to claim 5, wherein an end of the first air hole is passed through a surface of the first film away from the first air channel.

9. A keyboard structure, comprising:
a bottom plate;
the membrane circuit board of the keyboard according to claim 1, wherein the membrane circuit board is disposed on the bottom plate;
a rubber element disposed on the membrane circuit board;
a cap movably connected to the rubber element; and
a supporting assembly with two ends respectively connecting to the bottom plate and the cap.

10. The membrane circuit board of keyboard according to claim 9, wherein the first film comprises a first air hole, and an end of the first air hole is passed through a surface of the first film away from the first air channel.

11. The membrane circuit board of keyboard according to claim 9, wherein the first film comprises a first air hole, and the first air channel is in fluid communication with the first air hole.
